(19) United States
(12) Patent Application Publication
(10) Pub. No.: US 2025/0139490 A1
(43) Pub. Date: May 1, 2025

(54) ERROR CORRECTION ON QUANTUM DEVICES

(71) Applicant: Fujitsu Limited, Kawasaki-shi (JP)

(72) Inventors: Rutuja KSHIRSAGAR, Sunnyvale, CA (US); Pranav TRIVEDI, Berkeley, CA (US)

(73) Assignee: Fujitsu Limited, Kawasaki-shi (JP)

(21) Appl. No.: 18/497,903

(22) Filed: Oct. 30, 2023

(51) Int. Cl. G06N 10/70; G06N 10/20

(52) U.S. Cl. CPC G06N 10/70; G06N 10/20

(57) ABSTRACT

A method of quantum error correction may include obtaining a logical qubit including a logical state. The logical qubit may be encoded using a quantum code to determine states for a plurality of physical qubits, the quantum code including a first code generated based on a first set of generators and a second code generated based on a second set of generators, the first set of generators and the second set of generators including different cardinality. The method may further include adjusting physical states of the plurality of physical qubits in quantum hardware based on the determined states. One or more computations may be performed using the quantum hardware and the physical states of the plurality of physical qubits may be decoded using the quantum code to determine the logical state.

### FIELD

The present disclosure generally relates to error correction for quantum devices.

### BACKGROUND

Quantum computers may use quantum bits (“qubits”) capable of representing information as ones, zeroes, or ones and zeroes simultaneously. Quantum computers may perform some types of computations, such as optimization problems, integer factorization, simulation modeling, and/or data analysis, more efficiently and/or more accurately than classical computing systems. However, existing quantum computers may be classified as noisy intermediate-scale quantum (NISQ) devices because states of qubits can be changed by slight environmental interference. As such, existing quantum computers may have little fault-tolerance and have limited utility.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method of quantum error correction may include obtaining a logical qubit including a logical state. The logical qubit may be encoded using a quantum code to determine states for a plurality of physical qubits, the quantum code including a first code generated based on a first set of generators and a second code generated based on a second set of generators, the first set of generators and the second set of generators including different cardinality. The method may further include adjusting physical states of the plurality of physical qubits in quantum hardware based on the determined states. One or more computations may be performed using the quantum hardware and the physical states of the plurality of physical qubits may be decoded using the quantum code to determine the logical state.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a flow diagram illustrating error correction for quantum devices;

FIG. 2 is a flowchart of an example method of calculating a quantum code;

FIG. 3 is an example graph of a particular subset of potential code rates corresponding to a first code rate and a second code rate defining a quantum code rate;

FIG. 4 is a flowchart of an example method of quantum error correction;

FIG. 5 is an example computing system, all in accordance with one or more embodiments of the present disclosure.

### DETAILED DESCRIPTION

Quantum computers use quantum bits, or “qubits,” that are configured to store values of 0, 1, or a superposition of both 0 and 1. Because qubits are capable of simultaneously storing multiple values, quantum computers are capable of performing calculations more quickly than classical computers that use classical bits storing values of either 0 or 1. Consequently, quantum computers may more efficiently perform computations, such as for optimization problems, and improve computations in various technology fields, such as physics, chemistry, material design, drug discovery, and machine learning.

However, existing quantum computers may be referred to as Noisy Intermediate Scale Quantum (NISQ) devices because the computational performance of such quantum computers is constrained by current physical and technological limitations. The quantum computers sensitivity to external interference and reliability problems may be caused by the quantum hardware's susceptibility to error caused by quantum noise that disrupts operations of the quantum computers. The quantum noise may be due to stray electromagnetic radiation, material defects, or other external obstructions. Furthermore, qubits may exhibit quantum characteristics for a limited period of time, and computations performed by quantum computers involve measuring values associated with the qubits during the period of time in which the qubits exhibit quantum characteristics.

In some circumstances, quantum noise may impair effective quantum computation by causing qubits to fail to retain coherent quantum states for practical durations. For example, qubits may suffer from bit-flip errors and/or phase-flip errors. The bit-flip errors may include instances where a computational state of the qubits flip from 1 to 0 or vice versa. The phase-flip errors may include instances where phase of the qubits is affected. For instance, the qubits may rotate by a certain angle.

Accordingly, current approaches to quantum computing may be reliant on quantum error correction processes. One approach to quantum error correction involves a quantum code modeled after a classical error correction code such as low-density parity check (LDPC) codes. LDPC codes have been used to mitigate errors during data transmission by expanding message data (e.g., binary data source) and by encoding the message data with a parity check matrix that includes 0s and 1s. The expanded message data may be decoded by a receiver (e.g., the message data may be reconstructed to an original state). During decoding, some errors (e.g., flipped bits) may be detected and corrected using the LDPC codes.

In some circumstances, quantum low-density parity check (QLDPC) codes may follow a similar approach as the LDPC codes. QLDPC codes may be used to protect quantum information against errors. QLDPC codes may involve encoding a logical qubit including a logical state with multiple physical qubits. States of the physical qubits may be representative of the logical state. One or more quantum logic gates may be performed on the physical qubits to execute a quantum algorithm, during which one or more errors may occur due to faulty quantum logic gates and/or environmental factors, such a quantum noise. As a result, the states of the physical qubits may be affected by the one or more errors. The QLDPC code may be used to detect and/or correct the one or more errors, and the physical states may be decoded to determine the logical state originally carried by the logical qubit.

In some circumstances, a class of QLDPC codes called quantum tanner codes may be suitable for architectures with long-range gate connections, such as ion-trap, silicon-photonic, and Rydberg-interacting. The quantum tanner code may be defined by one or more characteristics such as rate and minimum distance. The rate may represent how effective the quantum tanner code uses physical resources (e.g., physical qubits) in quantum error correction process. For instance, the rate may be a ratio of a number of logical qubits to a total number of physical qubits. The minimum distance may represent an ability of the quantum tanner code to detect and correct errors. For instance, the minimum distance may correspond to a smallest number of physical qubits that may include an error before the quantum tanner code is unable to detect and/or correct errors. For instance, where the error affects fewer physical qubits than the minimum distance, the quantum tanner codes may be able to correct the error.

The present disclosure may relate to, among other things, a system and method related to improving the quantum tanner code by improving the rate and/or the minimum distance of the quantum tanner code. Some traditional approaches to generating quantum tanner code involves generating the quantum tanner code using sets of generators of the same cardinalities. A cardinality of a set of generators may represent a number of elements in the set. Two or more sets of generators may have the same cardinalities where there exists a one-to-one correspondence between the elements of the sets. However, by allowing the sets of generators to have different cardinalities, the rate and the minimum distance of the quantum tanner code may be improved.

Embodiments of the present disclosure are explained with reference to the accompanying figures.

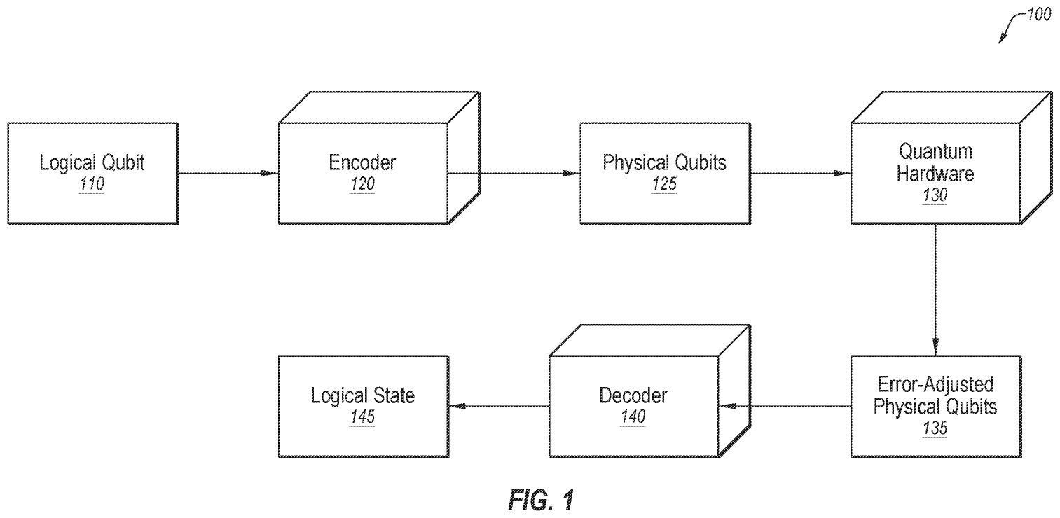

FIG. 1 is a flow diagram illustrating an example system 100 of error correction for quantum devices, in accordance with one or more embodiments of the present disclosure. In some embodiments, the system 100 may include an encoder 120, quantum hardware 130, and a decoder 140.

In some embodiments, the encoder 120 may include codes, steps, and/or methods used to encode a logical qubit 110 into a larger number of physical qubits 125. In these and other embodiments, the logical qubit 110 may refer to an abstract representation of a qubit that includes a logical state, where the logical state may refer to quantum information that is being stored and/or processed. For example, for a single qubit, the logical state may be a 0, 1, or a superposition of |0> and/or |1>. The physical qubits 125 may represent individual qubits that may be part of a quantum computer. For example, the physical qubits 125 may be basic units of quantum information implemented on physical systems such as superconducting circuits, trapped ions, and photon states.

In some embodiments, the physical qubits 125 may be sensitive to one or more external conditions that may cause errors. For example, the physical qubits 125 may be sensitive to noise, temperature fluctuations, electromagnetic radiation, gate errors, etc. In these and other embodiments, the errors may be reduced by encoding information of a single logical qubit into a joint state of multiple physical qubits. By encoding the single logical qubit into the joint state of multiple physical qubits, errors caused during processing of the quantum information due to the physical qubits may be detected and/or corrected.

In some embodiments, encoding of the logical qubits 110 may involve using a quantum error correction code (“quantum code”). For example, the quantum code may define how to encode and/or map a logical state of a logical qubit 110 onto states of multiple physical qubits 125. In these and other embodiments, different quantum codes may have characteristics such as a number of physical qubits 125 required, a number of encoded logical qubits, error detection capabilities, error correction capabilities, suitability for different quantum hardware platforms, among others.

In some embodiments, quantum codes may be characterized and/or describe using certain parameters. For example, the quantum codes may be characterized by code rates. A code rate of a quantum code may represent a ratio between a number of logical qubits and a number of physical qubits used to encode the logical qubits. For instance, the code rate may be calculated by dividing the number of logical qubits by the number of physical qubits used to encode the logical qubits. In these and other embodiments, a higher code rate may indicate that a smaller number of physical qubits are needed to encode the logical qubits, which may increase efficiency of the quantum code.

Additionally or alternatively, the quantum codes may be characterized by minimum distances. A minimum distance of a quantum code may represent a measurement of the quantum code's ability to detect and correct errors. For instance, the minimum distance may represent how many errors the quantum code may correct. For example, a particular quantum code with a minimum distance of five may be able to detect and/or correct any combination of four or fewer errors. In some embodiments, a greater minimum distance may be preferred to detect and/or correct greater number of errors.

In some embodiments, the quantum code may include quantum Tanner codes. The quantum Tanner codes may be a type of quantum low-density parity-check (LDPC) codes built from a concept of classical Tanner codes which are used to detect and correct errors in classical information transmission. In some embodiments, the quantum tanner codes may be used in a quantum setting to detect and correct errors in quantum information transmission.

In these and other embodiments, the quantum Tanner codes may be determined from a group G and at least two sets of generators (e.g., a first set of generators A and a second set of generators B) of the group G. In these and other embodiments, the group G may refer to an algebraic structure that includes one or more elements along with a binary operation that combines the elements in a certain way. In some instances, the group may be empty (e.g., no elements are included). The elements may be characters, such as numbers, letters, or any other characters. For example, a group may include three elements (e.g., {1, 2, 3}). The group may include all possible permutations of the three elements according to the binary operations of the group. Such binary operations may include identity permutation, transposition, and 3-cycle, among other binary operations that may be applied to the set of elements. In these or other embodiments, the sets of generators that may be used to determine the Tanner codes may be subsets of the elements of the set of the group that, through repeated application of group operations, may generate all elements of the group.

In some instances, the group G may be a non-empty set with elements satisfying associativity. For instance, any elements in the group G, such as a, b, and c, may satisfy (a*b)*c=a*(b*c), where “*” represents a binary operation. Additionally, the group G may include an identity element, e, such that for any element, g, in the group G, g*e may equal to e*g. In some instances, elements of the group G may have an inverse. For instance, for any element, a, in the group G, there may be a unique element i that satisfies a*i=i*a=e. In some embodiments, the group G may be an infinite group. For instance, the group G may include an uncountable (e.g., real numbers) or countable infinite (e.g., integers) number of elements.

Some previous approaches to determining the quantum Tanner codes based on the group G, the first set of generators A, and the second set of generators B may include an assumption that the first set of generators A and the second set of generators B include the same cardinalities or include the same number of elements in each set. For instance, the first set of generators A and the second set of generators B may be assumed to have a same number of elements to generate all elements of the group (e.g., |A|=|B|, |A| representing cardinality of A and |B| representing cardinality of B).

In some circumstances, the group G, the first set of generators A, and the second set of generators B may be used to generate a first classical code C_{A} and a second classical code C_{B}. Classical codes may include error-correcting codes that may be used to correct errors of classical information (e.g., digital and/or binary data). For example, the classical codes may be configured to detect and/or correct errors suffered by the classical information during transfer. In these and other embodiments, the first set of generators A may be used to generate the first classical code C_{A} and the second classical code C_{B}. Each of the classical codes may have a code rate. For example, the first classical code C_{A} may have a first code rate ρ_{A} and the second classical code C_{B} may have a second code rate ρ_{B}.

Some previous approaches may include an assumption that a sum of the first code rate ρ_{A} and the second code rate ρ_{B} is equal to 1. Stated mathematically, it may be assumed that ρ_{B}=(1−ρ_{A}).

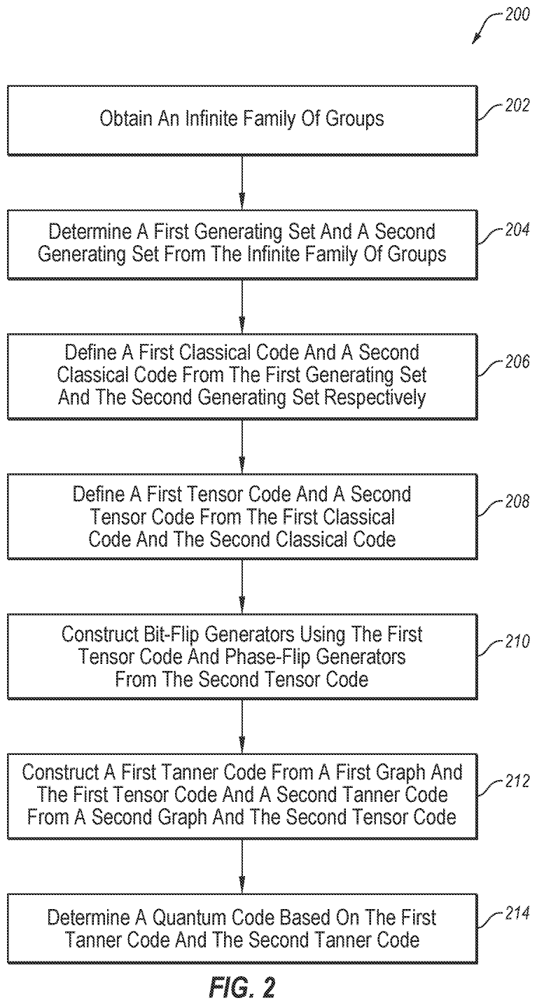

In some embodiments, the quantum code based on the traditional quantum Tanner codes may be generalized. In some embodiments, the generalized quantum codes may provide improved rate over Leverrier-Zemor quantum codes. In these and other embodiments, the generalized quantum codes may be generated without the assumptions made above. For example, it may not be assumed that the first set of generators A and the second set of generators B have a same cardinality or that the sum of the first code rate ρ_{A} and the second code rate ρ_{B} is 1. In some embodiments, by disregarding these assumptions, the quantum code may be improved. For example, the rate of the quantum code may be improved. An example method of determining the quantum code using the two classical codes may be described in further detail with respect to FIG. 2 of the present disclosure.

The rate of the quantum code, in accordance with one or more embodiments of the present disclosure (e.g., where |A|≠|B|), may be illustrated mathematically as: 2ρ_{A}+2ρ_{B}−4ρ_{A}ρ_{B}−1. In some embodiments, the rate may be proven based on following steps: First, dimensions of a first tensor code C₀ and a second tensor code C₁ may be determined (how to determine the first tensor code C₀ and the second tensor code C₁ may be described in further detail with respect to block 208 of FIG. 2 of the present disclosure). Stated mathematically, dimC₀=dimC_{A}·dimC_{B}=k₁k₂=ρ_{A}n₁ρ_{B}n₂, and dimC₁=dimC_{A}^{⊥}·dimC_{B}^{⊥}=(n₁−k₁)(n₂−k₂)=(1−ρ_{A})n₁(1−ρ_{B})n₂, where n₁ represents length of the first classical code C_{A} (e.g., the first determinant), n₂ represents length of the second classical code C_{B} (e.g., the second determinant), k₁ represents a dimension of the first classical code C_{A}, and k₂ represents a dimension of the second classical code C_{B}. A number of sets of generators and/or generators for the quantum code may be at most: |V₀| dimC₀+|V₁| dimC₁=(ρ_{A}ρ_{B}+(1−ρ_{A}) (1−ρ_{B}))n₁n₂|G|, where G represents a group used to generate the first set of generators and the second set of generators, and V₀=G×{0} and V₁=G×1.

The number of generators determined may provide an upper bound for a number of constraints for the Tanner codes generated using the tensor codes. As a result, a dimension of the quantum code, generated based on the Tanner codes, may be represented as:

$$\vert Q \vert - ( {ρ}_{A} {ρ}_{B} + ( 1 - {ρ}_{A} ) ( 1 - {ρ}_{B} ) ) {n}_{1} {n}_{2} \vert G \vert = \frac{\vert G \vert {n}_{1} {n}_{2}}{2} - ( {ρ}_{A} {ρ}_{B} + ( 1 - {ρ}_{A} ) ( 1 - {ρ}_{B} ) ) {n}_{1} {n}_{2} \vert G \vert = ( 1 - 2 ( {ρ}_{A} {ρ}_{B} + ( 1 - {ρ}_{A} ) ( 1 - {ρ}_{B} ) ) ) \vert Q \vert = ( 2 {ρ}_{A} + 2 {ρ}_{B} - 4 {ρ}_{A} {ρ}_{B} - 1 ) \vert Q \vert .$$

Accordingly, the rate of the quantum code may be at least =(2 ρ_{A}+2ρ_{B}−4ρ_{A}ρ_{B}−1), which is improved compared to (2ρ−1)² which is the rate in instances where ρ_{B}=(1−ρ_{A}).

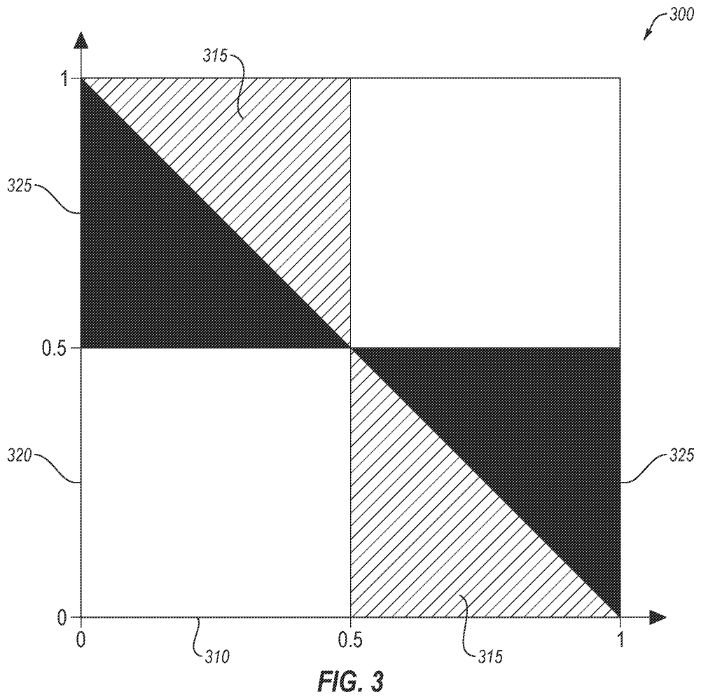

In some embodiments, the first code rate ρ_{A} and the second code rate ρ_{B} may be selected and/or determined to satisfy (2ρ_{A}+2ρ_{B}−4ρ_{A}ρ_{B}−1)≥(2ρ_{A}−1)². The relationship may be further simplified as (1−ρ_{A})(2ρ_{A}−1)≥ρ_{B}(2ρ_{A}−1) and (1−ρ_{B})(2ρ_{B}−1)≥ρ_{A}(2ρ_{B}−1) symmetrically. For instance, the rate of the quantum code as presented in the present disclosure may be improved compared to some traditional approaches in instances where the first code rate ρ_{A} and the second code rate ρ_{B} satisfy the equations above. Potential ranges of the first code rate ρ_{A} and the second code rate ρ_{B} may be described in further detail with respect to FIG. 3 of the present disclosure.

In some embodiments, the physical qubits 125 may be processed by the quantum hardware 130. In these and other embodiments, the quantum hardware 130 may refer to any physical device and/or systems suitable for quantum information processing. For example, the quantum hardware 130 may include superconducting qubits (e.g., qubit circuits made of superconducting materials that can be manipulated by microwave pulses), trapped ion quantum computers, photonic quantum computers, quantum annealers, topological quantum computers, quantum sensors, among others. In general, the quantum hardware 130 may include multiple quantum gates configured to manipulate the states of one or more qubits in the quantum hardware 130. The quantum gates may manipulate the states of the one or more qubits using one or more quantum algorithms. The quantum algorithms may use properties of the qubits, such as entanglement, superposition, and/or parallelism between states to perform certain functions of the quantum algorithms.

In some embodiments, the quantum hardware 130 may be configured to apply the quantum code to the physical qubits to mitigate the errors. For instance, the quantum hardware may generate and/or determine error-adjusted physical qubits 135. For example, the quantum hardware 130 may apply one or more quantum gates and/or operations to the physical qubits to reverse and/or mitigate the errors. The one or more quantum gates and/or the operations may be determined based on the quantum code.

In some embodiments, the error-adjusted physical qubits 135 may be obtained by the decoder 140. In these and other embodiments, the decoder 140 may be configured to determine the logical state 145 of the logical qubit 110. For instance, the decoder 140 may decode the physical states of the physical qubits using the quantum code to determine the logical state 145. For instance, the decoder 140 may be configured to retrieve the encoded quantum information from the physical qubits. The decoder 140 may use the encoded quantum information and the quantum code to decode the physical qubits to determine the logical state 145 of the logical qubit 110. For example, the decoder 140 may obtain the states of six physical qubits and based on the state information and the quantum code, determine the logical state of three qubits.

Modifications, additions, or omissions may be made to the system 100 without departing from the scope of the disclosure. For example, the designations of different elements in the manner described is meant to help explain concepts described herein and is not limiting.

FIG. 2 illustrates a flowchart of an example method 200 of determining a quantum code in accordance with at least one embodiment of the present disclosure. The method 200 may be performed by any suitable system, apparatus, or device. Although illustrated with discrete blocks, the steps and operations associated with one or more blocks of the method 200 may be divided into additional blocks, combined into fewer blocks, or eliminated, depending on the particular implementation.

The method 200 may begin at block 202, where an infinite family of groups G (e.g., |G|->∞) may be obtained. At block 204, multiple sets of generators defining the infinite family of groups may be determined. For example, a first set of generators A and a second set of generators B may be determined. In some embodiments, the first set of generators A and the second set of generators B may be determined so that the underlying geometric complex of the quantum code may be defined as a left-right Cayley complex X defined by Cay₂(A, G, B). where the first set of generators A and the second set of generators B are symmetric (e.g., A=A⁻¹, B=B⁻¹) and satisfy a total no-conjugacy condition (e.g., ag≠gb for any g∈ G, a∈ A, b∈ B). The complex X may be made of vertices and edges. The complex X, under some current approaches, may form a square with the vertices and the edges. According to one or more embodiments of the present disclosure, the complex X may form a rectangular complex instead of a square. In these and other embodiments, the vertex set may be the group G. The edges may include {g, ag}, {gb, agb}∈ E_{A}; {g, gb}, {ag, agb} ∈ E_{B}; {g, agb} ∈ E₀; and {ag, gb} ∈ E₁, where E_{A} is an edge set consisting of edges ((g, 0), (ag, 1)) for a ∈ A and E_{B} is an edge set consisting of pairs ((g, 0, (gb, 1)) for b ∈ B. The total no-conjugacy condition of the first set of generators A and the second set of generators B may ensure that each square has four distinct vertices, and that each vertex is adjacent to |A∥B|.

In some embodiments, the two Cayley graphs Cay (G, A) and Cay (G, B) may not be bipartite. For instance, the Cayley graphs may not exhibit clear separation into two distinct groups of vertices representing the physical qubits and check qubits (e.g., redundant qubits used for error detection). However, bipartite Cayley graphs may be used to represent structures of Tanner codes. In these and other embodiments, non-bipartite Cayley graphs may be turned bipartite by taking a double cover of the two Cayley graphs so that the two Cayley graphs are bipartite (e.g., V=V₀ [symbol] V₁, where V₀=G×{0} and V₁=G×1). In some instances, taking the double cover may include extending the Cayley graphs to provide a more complete representation of the group's structure and symmetries. In some embodiments, two bipartite graphs (e.g., [symbol] and [symbol] ) may be further defined from the Cayley graphs, where [symbol] =(V=V₀ ∪V₁, E_{A}) and [symbol] =(V, E_{B}). A set Q of the Cayley complex may be defined as a set of 4-subsets of vertices of form {(g, 0), (ag, 1), (bg, 1), (agb, 0)}. In some embodiments, two additional graphs may be generated from the Cayley complex by taking diagonals of the vertices as edges. For example, illustrated mathematically, a first graph and a second graph may be represented as, [symbol] =(V₀, Q) and [symbol] =(V₁, Q). In some embodiments, the first graph [symbol] and the second graph [symbol] may be used in constructing tanner codes which may be discussed with respect to block 212.

In some embodiments, the first set of generators and the second set of generators may include different cardinalities (e.g., |A|≠|B|). In these and other embodiments, the different cardinalities may improve the quantum code with respect to ratio and minimum distance of the quantum code. For example, the different cardinalities may affect code rates of a first classical code C_{A} and a second classical code C_{B}, which may affect and/or improve the rate and the minimum distance of the quantum code.

At block 206, the first classical code C_{A} and a second classical code C_{B} may be defined from the first set of generators A and the second set of generators B, respectively. In the present disclosure, a “classical code” may also refer to a linear code. In some embodiments, the first classical code may include a first length n_{A}, and the second classical code may include a second length n_{B}. In these and other embodiments, the first length n_{A} may be defined from the first set of generators A where n_{A}=|A|. Additionally or alternatively, the second length n_{B} may be defined from the second set of generators B where n_{B}=|B|. In some instances, because the first set of generators A and the second set of generators B may have different cardinalities, the first length n_{A} and the second length n_{B} may be different. In some embodiments, the first classical code C_{A} and the second classical code C_{B} may be such that C_{A} ⊂ F₂^{|A|}, and C_{B} ⊂F₂^{|B|}.

In some embodiments, the first classical code C_{A} and the second classical code C_{B} may be determined such that a dual tensor of the first classical code C_{A} and the second classical code C_{B} may be represented as (C_{A}^{⊥}⊗C_{B}^{⊥})^{⊥} which may be a dual of a tensor product of duals of the first classical code C_{A} and the second classical code C_{B} (e.g., C_{A} [symbol] C_{B}). In these and other embodiments, a parity check matrix for C_{A} [symbol] C_{B} may be H_{A} ⊗H_{B}, where H_{A} and H_{B} are parity check matrices of C_{A} and C_{B}, respectively. In these and other embodiments, C_{A} [symbol] C_{B} may be κ-product-expanding if any x∈ C_{A} [symbol] C_{B} can be expressed as c+r, with c∈ C_{A} ⊗F₂^{|B|} and r ∈ F₂^{|A|}⊗C_{B} such that

$$κ ( \frac{1}{\vert B \vert} {\vert \vert C \vert \vert}_{A} + \frac{1}{\vert A \vert} {\vert \vert r \vert \vert}_{B} ) \leq \frac{1}{\vert A \vert \vert B \vert} \vert x \vert ,$$

where ∥C∥_{A} denotes the number of non zero columns in c and ∥r∥_{B} denotes the number of non-zero rows in r.

In some embodiments, the first classical code C_{A} and the second classical code C_{B} may be constructed and/or determined based on a family of Morgenstern generators. For instance, each of the infinite family of groups G, defined as Gᵢ=PGL₂(qⁱ)=PSL₂(qⁱ), with q=2^{s}, may include a family of Morgenstern generators Aᵢ of 2^{s+1} generators where each element has an order greater than 2. The infinite family of groups G may further include a family of Morgenstern generators Bᵢ of 2^{s+1} generators where each element has an order of 2. In these and other embodiments, the first classical code C_{A} may be constructed as Reed-Solomon code [2^{s+1}, 2^{s}+2^{s+1-g+h}≥2^{g-1}−2^{h}+1] over

$${F}_{{2}^{{2}^{s + 1 - g}}} {C}_{A}^{⊥} :$$

Reed-Solomon code [2^{s+1}, 2^{s}+2^{s+1-g+h}≥2^{g-1}−2^{h}+1], and the second classical code C_{B} may be constructed as Reed Solomon code

$$[ {2}^{s + 1} , ( {2}^{s} + 1 ) ( \frac{b - 1}{2 b} ) , \geq \frac{b + 3}{2} ] over {F}_{{2}^{( {2}^{s + 1 ) / b}}} , {C}_{A}^{⊥} :$$

Reed-Solomon code

$$[ {2}^{s + 1} , ( {2}^{s} + 1 ) ( \frac{b - 1}{2 b} ) , \geq \frac{b + 1}{2} ] ,$$

where

$$g = ⌊ \frac{W ( {2}^{2 s + 1} log ( 2 ) )}{log ( 2 )} ⌋ , b := max \{ m ∈ N \vert m \vert 2 s + 1 and m \leq \frac{2 ( 2 s + 1 )}{m} \} ,$$

and h=└(1−ε)g┘ where ε>0. In these and other embodiments, rate of the quantum code generated using the first classical code C_{A} and the second classical code C_{B} may be at least

$$\frac{1}{b {2}^{g - h}} .$$

In some embodiments, the first classical code C_{A} and the second classical code C_{B} may be constructed and/or determined based on a family of Ramanujan and/or substantially Ramanujan generators. For instance, each of the infinite family of groups G, defined as Gᵢ=PGL₂(qⁱ)=PSL₂(qⁱ), with q=2^{l}, may include a family of substantially Ramanujan generators Aᵢ of 2q generators, where each element has an order greater than 2. The infinite family of groups G may further include a family of Ramanujan generators Bᵢ of q+1 generators where each element has an order of 2. In some instances, a family of λ-expanders left-right Cayley complexes for any

$$λ \geq \frac{3 \sqrt{2 q - 1}}{2 q}$$

may be obtained. In these and other embodiments, the first classical code C_{A} may be constructed as extended Hamming code [2^{2s+1}, 2^{2s+1}−2s−2, 4], where C_{A}^{⊥} is augmented Hadamard code [2^{2s+1,} 2s+2, 2^{2s}]. Further, the second classical code C_{B} may be constructed as Zetterberg code [2^{2s}+1, 2^{2s}−4s+1, 5≤d_{B}^{⊥}≤6], where C_{B} is irreducible cyclic code [2^{2s}+1, 4s, 2^{2s}−2^{s}+2], where [symbol] =2s, |Aᵢ|=2^{2s+1}, and |Bᵢ|=2^{2s}+1. In these and other embodiments, the rate of the quantum code may be at least

$$\frac{( {4}^{S} - 8 S + 1 ) ( {4}^{S} - 2 S - 2 )}{{4}^{S} + 1 {6}^{S}} ,$$

where as s->∞ the rate tends to 1.

At block 208, a first tensor code C₀ and a second tensor code C₁ may be defined from the first classical code C_{A} and the second classical code C_{B}. For example, the first tensor code C₀ may be a tensor product of the first classical code C_{A} and the second classical code C_{B}, and the second tensor code C₁ may be a tensor product of a dual of the first classical code C_{A} and a dual of the second classical code C_{B}. For instance, the first tensor code C₀ and the second tensor code C₁ may be represented mathematically as: C₀=C_{A} ⊗C_{B} and C₀=C_{A}^{⊥}⊗C_{B}^{⊥}. A tensor code of two codes such as C_{A} and C_{B} may include all matrices where each column is in C_{A} and each row is in C_{B}. Illustrated mathematically, given two linear codes Cᵢ⊆F_{q}ⁿⁱ, i=1, 2 (e.g., C_{A} and C_{B}), tensor product between the two linear codes may be illustrated as C₁ ⊗C₂:={c∈ F_{q}ⁿ^{₁}^{×n}^{₂}|∇i ∈[n₁], ∇j∈ [n₂]: c(·, j)∈ C₁, c(i,·)∈ C₂}, where F_{q}ⁿ^{₁}^{×n}^{₂} represents a space of n₁×n₂ matrices over F_{q}; and for a matrix c, c(·, j) represents a j-th column and c(i,·) represents an i-th row.

At block 210, bit-flip (Z) generators may be generated from the first tensor code and the phase-flip (X) generators may be generated from the second tensor code. In some embodiments, a first basis of β₀ of C₀ and a second basis of β₁ of C₁ may be determined. For instance, the first basis fib and the second basis β₁ may be sets of basis states that form code spaces of the first tensor code C₀ and the second tensor code C₁, respectively. The first basis β₀ and the second basis β₁ may represent possible states of the first tensor code C₀ and the second tensor code C₁ in the code spaces. For example, the first basis β₀ may represent all possible combinations of basis states for C_{A} and C_{B} and the second basis flu may represent all possible combinations of basis states for C_{A}^{⊥} and C_{B}^{⊥}. In these and other embodiments, the basis states for classical codes (e.g., C_{A} and C_{B}) may include sequences and or combinations of binary digits (e.g., 0s and 1s) that may be present in the classical codes. With respect to the quantum codes, the basis states may include valid quantum states within the code space which may be represented as tensor products of single-qubit basis states (e.g., |0 [symbol] and |1 [symbol] ). For example, the basis states of a 3-qubit tensor code may include: |000 [symbol] , |001 [symbol] , |010 [symbol] , |011 [symbol] , |100 [symbol] , |101 [symbol] , |110 [symbol] , and |111 [symbol] . In these instances, any valid encoded quantum states within the quantum code may be represented as a linear combination of the basis states. The bit-flip generators may be such that, illustrated mathematically, for each v ∈ V₀, define dim C₀ generators×∈ F₂^{Q} of type Z by requiring that xᵥ is equal to an element of β₀ and x_{w}=0 for all w∈ Q(v). In these and other embodiments, |V₁|dimC₁ generators of type X may be defined by imposing local view at v ∈ V₁ to eb equal to an element of β₁ and 0 for w ∉ Q(v). In some instances, the Z generators and the X generators may be orthogonal.

At block 212, a first tanner code [symbol] and a second tanner code [symbol] may be constructed. For example, the first tanner code [symbol] may be constructed from the first graph [symbol] and the first tensor code C₀, and the second tanner code [symbol] may be constructed from the second graph [symbol] and the second tensor code C₁. In these and other embodiments, the first tanner code [symbol] may be orthogonal to the Z generators and may be defined as a set of vectors x ∈ F₂^{Q} such that xᵥ ∈ C₀^{⊥}. The second tanner code [symbol] may be orthogonal to the X generators in a similar manner. For example, the first tanner code [symbol] and the second tanner code [symbol] may be illustrated mathematically as, [symbol] =T( [symbol] , C₀^{⊥}) and [symbol] , =T ( [symbol] , C₁^{⊥}).

At block 214, the quantum code [symbol] may be determined based on the first tanner code [symbol] and the second tanner code [symbol] . For example, the quantum code [symbol] may be represented mathematically as [symbol] =( [symbol] , [symbol] ). In some embodiments, the quantum code [symbol] may be an asymptotically optimal code. For example, the quantum code [symbol] may satisfy k=θ(n) and d=θ(n). Such quantum code [symbol] may be decoded in linear time.

In some embodiments, the quantum code [symbol] may include a quantum code rate defined using a first code rate ρ_{A} of the first classical code C_{A} and a second code rate ρ_{B} of the second classical code C_{B}. For example, the quantum code rate may be represented as at least 2ρ_{A}+2ρ_{B}−4ρ_{A}ρ_{B}−1. In these and other embodiments, the first code rate ρ_{A} and the second code rate ρ_{B} may be defined from dimensions of the first tensor code C₀ (e.g., dim C₀) and the second tensor code C₁ (e.g., dim C₁), such that dim C₀=dim C_{A}·dim C_{B}=k₁k₂=ρ_{A}n₁ρ_{B}n₂, and dim C₁=dim C_{A}^{⊥}·dim C_{B}^{⊥}=(n₁−k₁)(n₂−k₂)=(1−ρ_{A})n₁(1−ρ_{B})n₂, where |A|=n₁ and |B|=n₂. The quantum code rate may be an improvement from some of the traditional approaches of the quantum code where n₁=n₂ (e.g., |A|=|B|). For instance, where the first length and the second length are the same, the quantum code rate may be represented as (2ρ−1)².

In these and other embodiments, to help increase a quantum code rate (e.g., (2ρ_{A}+2ρ_{B}−4ρ_{A}ρ_{B}−1)≥(2ρ−1)², the first code rate ρ_{A} and the second code rate ρ_{B} may be selected from a particular subset of potential code rates. The particular subset may be selected such that the quantum code rate is greater than a code where the first code rate ρ_{A} equals one minus the second code rate ρ_{B}. An example of the particular subset of potential code rates may be illustrated in FIG. 3.

The quantum code [symbol] , in accordance with one or more embodiments of the present disclosure may have an improved minimum distance compared to quantum codes determined based on some traditional approaches where the first set of generators A and the second set of generators B include the same cardinalities. For example, the minimum distance of some traditional approaches may be represented as

$$\frac{{δ}^{2} {k}^{2} n}{256 Δ} ,$$

where

$$n = \frac{\vert G \vert {Δ}^{2}}{2} , and k = \frac{1}{2} min \{ \frac{1}{4} {H}_{2}^{- 1} ( \frac{{ρ}_{A}}{8} ) {H}_{2}^{- 1} ( \frac{{ρ}_{B}}{8} ) , {H}_{2}^{- 1} ( \frac{( {ρ}_{A} ) ( {ρ}_{B} )}{8} ) \} .$$

Contrastingly, the minimum distance of the quantum code [symbol] may be at least

$$\frac{{δ}^{2} min {\{ {k}_{0} , {k}_{1} \}}^{2} n}{1024 max \{ {n}_{A} , {n}_{B} \}} , where n = \frac{\vert G \vert {n}_{A} , {n}_{B}}{2} , {k}_{0} = \frac{1}{2} min \{ \frac{1}{4} {H}_{2}^{- 1} ( \frac{1 - {ρ}_{A}}{8} ) {H}_{2}^{- 1} ( \frac{1 - {ρ}_{B}}{8} ) , {H}_{2}^{- 1} ( \frac{( 1 - {ρ}_{A} ) ( 1 - {ρ}_{B} )}{8} ) \} , and {k}_{1} = \frac{1}{2} min \{ \frac{1}{4} {H}_{2}^{- 1} ( \frac{{ρ}_{A}}{8} ) , {H}_{2}^{- 1} ( \frac{( {ρ}_{A} ) ( {ρ}_{B} )}{8} ) \} .$$

In these and other embodiments, H₂⁻1 may be an inverse (e.g., H₂⁻1: [0, 1]->[0, 1−1/q]) of an entropy function H₂: [0, 1]->[0, 1], where H₂ (x)=−x log₂ (x)−(1−x) log₂ (1−x), where H₂⁻1(y) is a unique x ∈[0, ½] such that H₂ (x)=y.

Modifications, additions, or omissions may be made to the method 200 without departing from the scope of the disclosure. For example, the designations of different elements in the manner described is meant to help explain concepts described herein and is not limiting. Further, the method 200 may include any number of other elements or may be implemented within other systems or contexts than those described.

FIG. 3 illustrates an example graph 300 of a particular subset of potential code rates corresponding to a first code rate and a second code rate defining a quantum code rate. For example, the particular subset of potential code rates may correspond to the particular subset discussed in FIG. 2. The graph 300 may include a first axis 310 a second axis 320.

In some embodiments, the particular subset may include a first subset 315 and a second subset 325. In these instances, the quantum code rate may be improved when the first code rate ρ_{A} is selected from the first subset 315 and the second code rate ρ_{B} is selected from the second subset 325. In these and other embodiments, the first code rate ρ_{A} and the second code rate ρ_{B} may be such that the second code rate ρ_{B} is one minus the first code rate ρ_{A} (e.g., ρ_{B}=1−ρ_{A}). In some embodiments, the quantum code rate, ρ( [symbol] ) may be defined as ρ( [symbol] )≥(2ρ_{B}−1)², which may be further represented as ρ( [symbol] )≥>2ρ_{A}+2ρ_{B}−4ρ_{A}ρ_{B}−1.

In these and other embodiments, the first subset 315 may be defined as (1−ρ_{A}) (2ρ_{A}−1)≥ρ_{B}(2ρ_{A}−1), and the second subset 325 may be defined as (1−ρ_{B})(2ρ_{B}−1)≥ρ_{A}(2ρ_{B}−1). In these and other embodiments, the first subset 315 and the second subset 325 may be defined as triangle-shaped regions with respect to the first axis 310 and the second axis 320. In some embodiments, the first subset 315 may include a first portion and a second portion. For example, the first portion may be defined using vertices (0, 1), (0.5, 1), and (0.5, 0.5), and the second portion may be defined using vertices (0.5, 0), (0.5, 0.5), and (1, 0). In these and other embodiments, the second subset 325 may include a first portion and a second portion. For example, the first portion may be defined using vertices (0, 0.5), (0,1), and (0.5, 0.5), and the second portion may be defined using vertices (1, 0), (1, 0.5), and (0.5, 0.5). In some embodiments, the first subset 315 and the second subset 325 may be defined as larger or smaller areas than depicted in FIG. 3. For instance, the first subset 315 and the second subset 325 may be defined as any suitable number satisfying the relationships provided above.

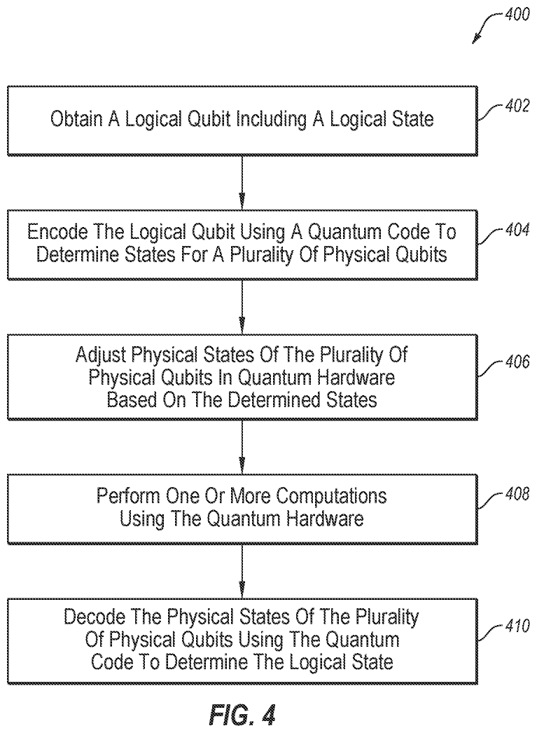

FIG. 4 illustrates a flowchart of an example method 400 of quantum error correction. The method 400 may be arranged in accordance with at least one embodiment described in the present disclosure. In these and other embodiments, one or more of the steps or none of the steps of the method 400 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 400 may include block 402. At block 402, a logical qubit including a logical state may be obtained. In some embodiments, the logical state may correspond to quantum information that is subject to being encoded and/or protected to be transferred and/or processed.

At block 404, the logical qubit may be encoded using a quantum code to determine states for multiple physical qubits. In some embodiments, the quantum code may include a first code generated based on a first set of generators and a second code generated based on a second set of generators. In these and other embodiments, the first set of generators and the second set of generators may include different cardinality. Additionally or alternatively, the first set of generators and the second set of generators may be subsets of a group. In some embodiments, the group may be an infinite group. In some embodiments, the first code may include bit-flip generators, and the second code may include phase-flip generators.

In some embodiments, the quantum code may include a quantum code rate that is selected from a particular subset of potential code rates. In some embodiments, the particular subset may be selected such that the quantum code rate is greater than a code rate where a first code rate equals one minus a second rate, where the first code rate is of the first code and the second code rate is of the second code. In some embodiments, the first code rate may be determined using a dimensionality of the first set of generators and the second code rate may be determined using a dimensionality of the second set of generators.

In some embodiments, encoding the logical qubit into the physical qubits may include mapping the logical state of the logical qubit onto the physical qubits. For instance, a two-dimensional array of physical qubits may be obtained. In some embodiments, the physical qubits may be organized in a shape of a lattice. In these and other embodiments, the physical qubits may be basic units of quantum information implemented on physical systems. In some embodiments, physical states of the physical qubits may be initialized. For example, the physical states may be initialized to |0> state. The initialized physical states may be adjusted using the quantum code.

In some embodiments, errors within the physical qubit may be detected. For example, any changes within the physical states corresponding to the logical state may be determined using the quantum code.

At block 406, physical states of the multiple physical qubits may be adjusted in quantum hardware based on the determined states. For instance, the quantum information carried by the logical qubit may be encoded across multiple physical qubits. The redundancy across the multiple physical qubits may be used to determine errors in one or more physical qubits. In some embodiments, the errors may be addressed by physically adjusting the physical states of the physical qubits using the quantum hardware.

At block 408, one or more computations may be performed using the quantum hardware. For example, the quantum hardware may be used to process and/or manipulate the quantum information carried by the physical qubits. For instance, quantum computations and/or logical operations may be performed using the physical qubits.

At block 410, the physical states of the multiple physical qubits may be decoded using the quantum code to determine the logical state. In some embodiments, the quantum code may include algorithms suitable for recovering the logical state form the physical qubits.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

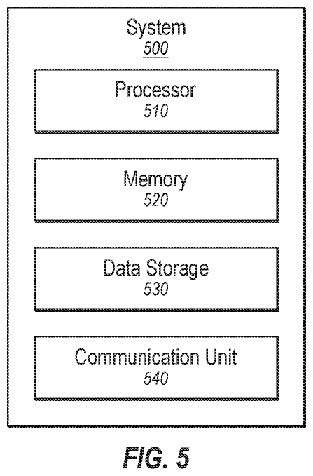

FIG. 5 illustrates an example computing system 500, according to at least one embodiment described in the present disclosure. The computing system 500 may include a processor 510, a memory 520, a data storage 530, and/or a communication unit 540, which all may be communicatively coupled. In some embodiments, any steps and/or portions of the method 200 of FIG. 2 and the method 400 of FIG. 4 that are not performed and/or executed by a quantum hardware or a quantum computer may be implemented by a computing system consistent with the computing system 500.

Generally, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 510 may include any number of processors distributed across any number of network or physical locations that are configured to perform individually or collectively any number of operations described in the present disclosure. In some embodiments, the processor 510 may interpret and/or execute program instructions and/or process data stored in the memory 520, the data storage 530, or the memory 520 and the data storage 530. In some embodiments, the processor 510 may fetch program instructions from the data storage 530 and load the program instructions into the memory 520.

After the program instructions are loaded into the memory 520, the processor 510 may execute the program instructions, such as instructions to perform the method 200 of FIG. 2 and method 400 of FIG. 4. For example, the processor 510 may obtain the first data distributions, simulate a classical circuit corresponding to the first quantum circuit, obtain the noiseless data distribution, determine the error mitigation parameter, and/or apply the error mitigation parameter to the second data distribution.

The memory 520 and the data storage 530 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 510. In some embodiments, the computing system 500 may or may not include either of the memory 520 and the data storage 530.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

The communication unit 540 may include any component, device, system, or combination thereof that is configured to transmit or receive information over a network. In some embodiments, the communication unit 540 may communicate with other devices at other locations, the same location, or even other components within the same system. For example, the communication unit 540 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 540 may permit data to be exchanged with a network and/or any other devices or systems described in the present disclosure. For example, the communication unit 540 may allow the system 500 to communicate with other systems, such as computing devices and/or other networks.

One skilled in the art, after reviewing this disclosure, may recognize that modifications, additions, or omissions may be made to the system 500 without departing from the scope of the present disclosure. For example, the system 500 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”)

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
obtaining a logical qubit including a logical state;
encoding the logical qubit using a quantum code to determine states for a plurality of physical qubits, the quantum code including a first code generated based on a first set of generators and a second code generated based on a second set of generators, the first set of generators and the second set of generators including different cardinality;
adjusting physical states of the plurality of physical qubits in quantum hardware based on the determined states;
performing one or more computations using the quantum hardware; and
decoding the physical states of the plurality of physical qubits using the quantum code to determine the logical state.

2. The method of claim 1, wherein a quantum code rate of the quantum code is selected from a particular subset of potential code rates, the particular subset selected such that the quantum code rate is greater than a code rate where a first code rate equals one minus a second code rate, where the first code rate is of the first code and the second code rate is of the second code.

3. The method of claim 2, wherein the first code rate is determined using a dimensionality of the first set of generators and the second code rate is determined using a dimensionality of the second set of generators.

4. The method of claim 2, wherein the first code rate is between 0.5 and 1, and the second code rate is between 0 and 0.5.

5. The method of claim 2, wherein the first code rate is between 0 and 0.5, and the second code rate is between 0.5 and 1.

6. The method of claim 1, wherein the first set of generators and the second set of generators are symmetric subsets of a group.

7. The method of claim 6, wherein the group is an infinite group.

8. The method of claim 1, wherein the first code includes bit-flip generators and the second code includes phase-flip generators.

9. The method of claim 1, wherein the encoding the logical qubit with the plurality of physical qubits include mapping the logical qubit logical state of the logical qubit to the plurality of physical qubits.

10. One or more non-transitory computer-readable media storing instructions that, when executed by one or more processors, cause a system to perform operations, the operations comprising:
obtaining a logical qubit including a logical state;
encoding the logical qubit using a quantum code to determine states for a plurality of physical qubits, the quantum code including a first code generated based on a first set of generators and a second code generated based on a second set of generators, the first set of generators and the second set of generators including different cardinality;
adjusting physical states of the plurality of physical qubits in quantum hardware based on the determined states;
performing one or more computations using the quantum hardware; and
decoding the physical states of the plurality of physical qubits using the quantum code to determine the logical state.

11. The one or more non-transitory computer-readable media of claim 10, wherein a quantum code rate of the quantum code is selected from a particular subset of potential code rates, the particular subset selected such that the quantum code rate is greater than a code rate where a first code rate equals one minus a second code rate, where the first code rate is of the first code and the second code rate is of the second code.

12. The one or more non-transitory computer-readable media of claim 11, wherein the first code rate is determined using a dimensionality of the first set of generators and the second code rate is determined using a dimensionality of the second set of generators.

13. The one or more non-transitory computer-readable media of claim 11, wherein the first code rate is between 0.5 and 1, and the second code rate is between 0 and 0.5.

14. The one or more non-transitory computer-readable media of claim 11, wherein the first code rate is between 0 and 0.5, and the second code rate is between 0.5 and 1.

15. The one or more non-transitory computer-readable media of claim 10, wherein the first set of generators and the second set of generators are symmetric subsets of a group.

16. The one or more non-transitory computer-readable media of claim 15, wherein the group is an infinite group.

17. The one or more non-transitory computer-readable media of claim 10, wherein the first code includes bit-flip generators, and the second code includes phase-flip generators.

18. The one or more non-transitory computer-readable media of claim 10, wherein the encoding the logical qubit with the plurality of physical qubits include mapping the logical qubit logical state of the logical qubit to the plurality of physical qubits.

19. A system, comprising:
one or more processors; and
one or more non-transitory computer-readable storage media configured to store instructions that, in response to being executed, cause the system to perform operations, the operations comprising:
obtaining a logical qubit including a logical state;
encoding the logical qubit using a quantum code to determine states for a plurality of physical qubits, the quantum code including a first code generated based on a first set of generators and a second code generated based on a second set of generators, the first set of generators and the second set of generators including different cardinality;
adjusting physical states of the plurality of physical qubits in quantum hardware based on the determined states;
performing one or more computations using the quantum hardware; and
decoding the physical states of the plurality of physical qubits using the quantum code to determine the logical state.

20. The system of claim 19, wherein a quantum code rate of the quantum code is selected from a particular subset of potential code rates, the particular subset selected such that the quantum code rate is greater than a code rate where a first code rate equals one minus a second code rate, where the first code rate is of the first code and the second code rate is of the second code.
